(19) United States
(12) Patent Application Publication
(10) Pub. No.: US 2025/0066233 A1
(43) Pub. Date: Feb. 27, 2025

(54) Carbon Block Vessel Device for Use in Water Purification for Dialysis Systems

(71) Applicant: Specialty Water Technologies, Portland, TN (US)

(72) Inventors: Seth Aric Barker, Portland, TX (US); Vincent Thomas Barker, Portland, TN (US)

(21) Appl. No.: 18/804,851

(22) Filed: Aug. 14, 2024

Related U.S. Application Data
(60) Provisional application No. 63/534,497, filed on Aug. 24, 2023.

(51) Int. Cl. C02F 9/20; C02F 1/00; C02F 1/28; C02F 1/32; C02F 101/12; C02F 103/02

(52) U.S. Cl. CPC C02F 9/20; C02F 1/004; C02F 1/283; C02F 1/32; C02F 2101/12; C02F 2103/026; C02F 2201/006; C02F 2209/03; C02F 2209/29; C02F 2301/043; C02F 2303/04

(57) ABSTRACT

A scalable water purification system for large-scale dialysis applications comprises a first carbon block vessel (worker vessel) connected in series to a second carbon block vessel (polisher vessel). The system includes one or more drain ports, air purge ports, pressure sensors, and sampling ports for monitoring and maintenance. A metal frame with levelling casters provides mobility, while at least one bypass valve allows the worker vessel to be bypassed for performance testing. Additional features include a multi-cartridge filtration unit for further contaminant removal, a UV-filtration unit for limiting biological growth, and a chlorine monitor for measuring chlorine and chloramine levels at various stages of water processing. This innovative design enhances water purification efficiency, reduces water usage, and simplifies maintenance compared to traditional granular activated carbon (GAC) systems.

### CROSS REFERENCE TO RELATED APPLICATION(S)

This application is based on the U.S. provisional patent application filed on Aug. 24, 2023, Ser. No. 63/534,497, and claims a filing date priority based on said application.

### STATEMENT REGARDING FEDERALLY SPONSORED RESEARCH OR DEVELOPMENT

This invention is not the result of any federally sponsored research or development.

### TECHNICAL FIELD

The present application relates to the technical field of dialysis systems, and in particular, relates to a carbon block vessel for water purification for dialysis processes.

### BACKGROUND OF INVENTION

The following description includes information that may be useful in understanding the present disclosure. It is not an admission that any of the information provided herein is prior art or relevant to the present disclosure, or that any publication specifically or implicitly referenced is prior art.

In the medical field of dialysis at large-scale clinical levels, water purification is a critical component for ensuring patient safety and the effectiveness of treatment. Traditionally, granular activated carbon (GAC) tanks have been employed to remove contaminants, primarily chlorine & chloramines from potable water used in dialysis systems. GAC consists of loose grains of carbon that effectively adsorb impurities from the water. However, GAC systems have a significant drawback: they require regular backwashing. Backwashing is a process where the flow direction is reversed to fluidize the carbon bed, breaking up channeling that occurs over time reducing the contact time, therefore lowering the adsorption of chlorine & chloramines. This process is water-intensive, significantly increasing the amount of water consumed in the purification process.

On the other hand, carbon blocks are utilized in small-scale acute dialysis settings. These settings typically use small carbon blocks housed in vessels that accommodate only one block. Unlike GAC, which is composed of loose grains, carbon blocks are made by compressing powdered carbon into cylindrical shapes. This compression process prevents the channeling issues seen with GAC, eliminating the need for backwashing. Consequently, carbon block systems require substantially less water for maintenance, offering a more efficient and sustainable solution for water purification.

While carbon blocks have been used in small-scaled systems, they have not been used in large-scale systems because of the difficulty in installing, repairing and replacing large carbon blocks, which are large, heavy and cumbersome to deal with.

Despite the advantages of carbon blocks in small-scale settings, the dialysis industry at large-scale clinical levels continue to rely on GAC systems due to their capacity to handle higher volumes of water. The frequent need for backwashing in these systems leads to excessive water usage, operational complexity, and increased costs. There is a clear need for a more efficient, scalable solution that combines the high capacity of GAC systems with the low maintenance and water efficiency of carbon block technology.

### SUMMARY OF INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

One aspect of the present disclosure relates to a scalable water purification system tailored for large-scale dialysis applications. The system features two carbon block vessels connected in series: a first vessel acting as a worker vessel for primary contaminant removal and a second vessel functioning as a polisher vessel to eliminate any remaining impurities and provide a safeguard against worker vessel failure. The system includes one or more drain ports on both the worker and polisher vessels. The drain ports facilitate easy maintenance and replacement of carbon blocks by allowing for efficient drainage of the vessels.

The system is equipped with one or more pressure sensors. The sensors are connected to the vessels to measure and automatically monitor the water pressure at various critical points, including the inlet of the worker vessel, between the worker and polisher vessels, and the outlet of the polisher vessel.

The apparatus of the invention includes a first carbon block vessel connected to a second carbon block vessel, wherein the first carbon block vessel and the second carbon block vessel are connected in series, the first carbon block vessel functions as a worker vessel, and the second carbon block vessel functions as a polisher vessel. One or more drain ports are disposed on the first and second carbon block vessels and the system has a metal frame which includes levelling casters.

In an exemplary embodiment, the worker vessel and the polisher vessel each contain multiple carbon blocks for water filtration.

In an exemplary embodiment, the system includes a multi-cartridge filtration unit connected in series with the second carbon block vessel for additional contaminant removal, a UV-filtration unit connected in series with multi-cartridge filtration unit for limiting biological growth by exposing water to ultraviolet light, and a chlorine monitor connected to the apparatus for measuring chlorine levels in incoming water, water processed by the first carbon block vessel, and water processed by the second carbon block vessel.

In one aspect, the system also integrates additional components such as a multi-cartridge filtration unit, a UV-filtration unit, and a chlorine monitor. The multi-cartridge filtration unit further removes contaminants of varying sizes, while the UV-filtration unit limits biological growth by exposing water to ultraviolet light, and the chlorine monitor samples and measures chlorine levels at various sampling points. The entire system is mounted on a sturdy metal frame with levelling casters, providing stability and easy mobility within dialysis facilities. This comprehensive design not only optimizes water purification for dialysis but also significantly reduces water usage and operational complexity compared to traditional GAC systems, making it a cost-effective and sustainable solution for large-scale dialysis applications.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates a perspective view of the dialysis water carbon block vessel purification system of the present invention in accordance with the disclosed structure;

FIG. 2 illustrates a front view of the system with lids of the vessels open in accordance with one embodiment of the disclosed structure;

FIG. 3 illustrates a side view of the dialysis water carbon block vessel purification system in accordance with one embodiment of the disclosed structure;

FIG. 4 illustrates internal view of the vessels showing the carbon blocks in accordance with one embodiment of the disclosed structure;

FIG. 5 illustrates back view of the dialysis water carbon block vessel purification system in accordance with one embodiment of the disclosed structure;

FIG. 6 illustrates a side view of the dialysis water carbon block vessel purification system showing the flow of water from the polisher vessel to multi-cartridge filtration unit and then to the UV module in accordance with one embodiment of the disclosed structure;

FIG. 7 illustrates a front view of the system with lids of the vessels closed in accordance with one embodiment of the disclosed structure; and

FIG. 8 illustrates a flow chart depicting a process of operation of the scalable carbon block water purification system for large-scale dialysis applications system of the present invention in accordance with the disclosed structure.

The figures depict embodiments of the disclosure for purposes of illustration only. One skilled in the art will readily recognize from the following description that alternative embodiments in of the structures and methods illustrated herein may be employed without departing from the principles of the disclosure described herein.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprise”, “comprising”, “include(s)”, or any other variations thereof, are intended to cover a non-exclusive inclusion, such that a setup, system or method that comprises a list of components or steps does not include only those components or steps but may include other components or steps not expressly listed or inherent to such setup or system or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

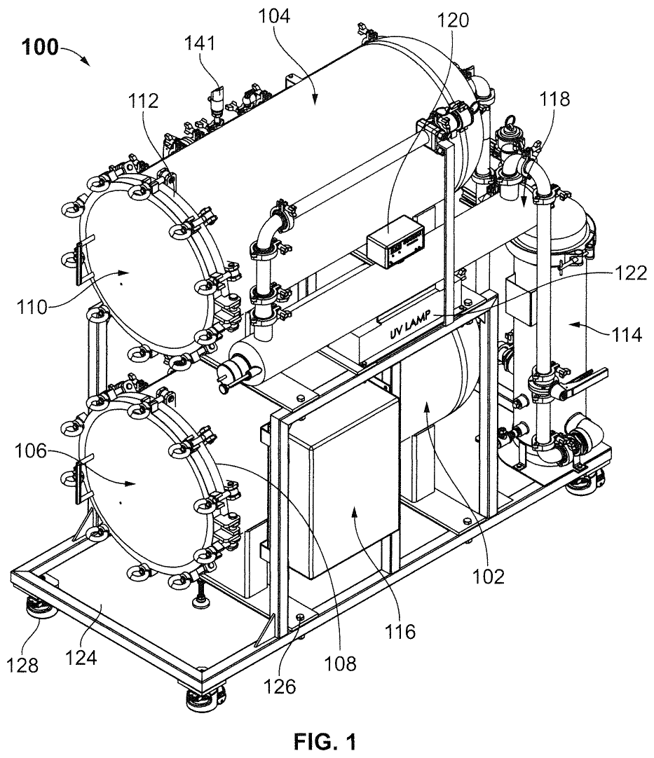

Reference will now be made to the exemplary embodiments of the disclosure, as illustrated in the accompanying drawings. Wherever possible, same numerals will be used to refer to the same or like parts. Embodiments of the disclosure are described in the following paragraphs with reference to FIGS. 1-8.

The present invention addresses the limitations of existing GAC systems by introducing a scalable, efficient water purification system based on carbon block technology. Furthermore, while carbon blocks have been used in small-scaled systems, use of large-scaled carbon blocks in institutional type applications has not been possible because the size, weight and shape of large-scale blocks prevented their use in larger systems. The present invention enables use of large carbon blocks in a way that heretofore has not been possible because the present invention is configured in a way to provide access to the blocks and easy removal, maintenance and replacement of such blocks. The design comprises large carbon block vessels capable of holding multiple carbon blocks, arranged in a worker and polisher configuration. This setup ensures thorough contaminant removal while maintaining the low maintenance and high efficiency characteristics of carbon block systems. The series connection of the worker and polisher vessels enhances filtration effectiveness, providing a reliable safeguard against system failure.

Referring to FIGS. 1-8, the scalable carbon block water purification system for large-scale dialysis applications system 100 includes at least two carbon block vessels 102, 104 (such as IHF-4-40-4F-4-E-225, manufactured and distributed by Liquid Filter Housings) which are adapted to be connected in series. As can be seen from FIGS. 1-8, both vessels 102, 104, are mounted horizontally. Small-scale systems have tanks/housings (with carbon blocks) mounted vertically with caps at the top of the housings and the housings are disconnected from the caps so that the housing and the carbon blocks can be removed from the system. This allows the carbon blocks to be removed from the housing and easily repaired or replaced. This arrangement works for small-scale systems because these small-scale units have carbon blocks that are 10″ to 20″ max length. Conversely, the small-scale units cannot be scaled to larger applications because the carbon blocks in the large-scale applications are 40″ to 60″ and cannot be handled in the manner that smaller carbon blocks are handled. And the small-scaled systems are not configured and constructed to mount horizontally because when the tanks/housing are disconnected, water would spill and create safety hazards. Preferably, in the present disclosure, the first carbon block vessel 102 is also referred to as the worker vessel and the second carbon block vessel 104 is also referred to as the polisher vessel. The worker vessel 102 is configured to handle the primary removal of water contaminants. The polisher vessel 104 is designed to remove any remaining contaminants and to act as a safeguard in case the worker vessel fails. The carbon block vessels 102, 104 are large in size (generally the vessels are 40″ to 60″ in length, or more) to be used in a large-scale dialysis set up. The worker vessel 102 includes a worker vessel lid 106 disposed at one end 108 of the worker vessel 102. A polisher vessel lid 110 is disposed on the end 112 of the polisher vessel 104 and is designed to be positioned directly above the worker vessel lid 106. Said lids can be removed to allow access to the large carbon blocks.

The system 100 includes a multi-cartridge filtration unit 114 (such as ESC5202NB410, manufactured and distributed by Pentair) which utilizes filament fibres or other methods of occlusion for removing contaminants of various sizes from water. In some embodiments of the present invention, the multi-cartridge filtration unit 114 is optional and may be removed from the system 100 as per preferences of the users. A chlorine monitor/analyser 116 (such as CM130, manufactured and distributed by Hach) is included in the system 100 for monitoring chlorine level in the water at different stages of the water filtration. If chlorine levels in the water are above the norm (generally 0.10 mg/l), the system is set to alert the user of the non-conformity, and this generally means that the carbon blocks need to be replaced. The analyser 116 is adapted to measure chlorine level in incoming water, in water processed by the worker vessel 102 and in water processed by the polisher vessel 104. In some embodiments of the present invention, the chlorine monitor/analyser 116 is optional and may be removed from the system 100 as per preferences of the users.

The system 100 includes a UV sterilization unit 118 (such as Sanitronic S2400C-120, manufactured and distributed by Atlantic Ultraviolet Corporation) which utilizes a high intensity UV lamp for limiting biological growth by exposing water to ultraviolet light. A UV light intensity monitor 120 (such as Guardian 30-8251, manufactured and distributed by Atlantic Ultraviolet Corporation) is adapted to monitor intensity of UV light produced by the UV lamp. When a UV sterilization unit is utilized, it must be preceded by a multi-cartridge filtration unit. In some embodiments of the present invention, the UV sterilization unit 118 is optional and may be removed from the system 100 as per preferences of the users.

The system 100 is built on a metal frame 124 and is bolted thereon using a plurality of fasteners 126 for stability. Further, the system 100 includes a plurality of 360-degrees rotatable casters with levelling feet 128, allowing for easy mobility and installation in water treatment rooms. The system 100 of the present invention is more convenient than traditional GAC (granular activated carbon) tanks, which require two-wheel hand trucks for movement, posing higher installation difficulty and injury risk. The system 100 also provides significant space savings over GAC tanks (approximately 20 sqft less space needed versus GAC tanks at equivalent flow rates).

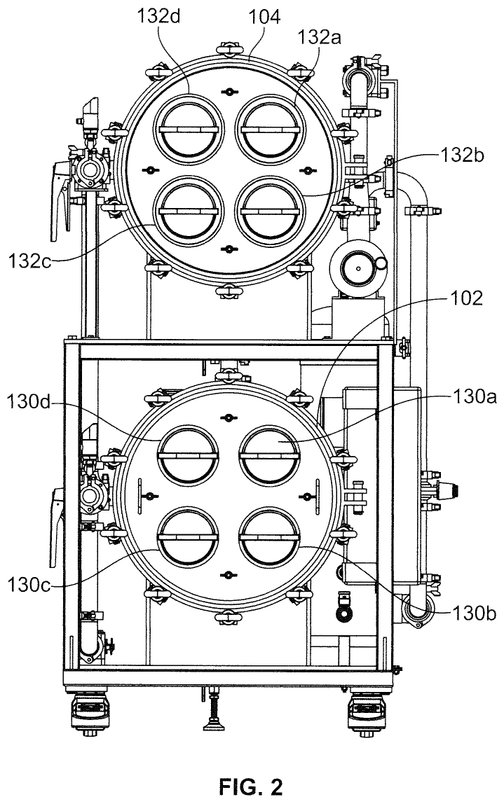

Referring to FIG. 2, the worker vessel 102 includes a plurality of carbon blocks 130a-d (such as CBE1S9SID, manufactured and distributed by American Melt Blown and Filtration), and the polisher vessel 104 includes a plurality of corresponding carbon blocks 132a-d for removal of chlorine & chloramines as well as other chemical contaminants in process water. The worker vessel 102 is the first vessel in the series of the vessels in the system 100 and performs the bulk of water contaminant removal. The polisher vessel 104 is the second vessel in the series and is adapted to remove any residual water contaminates. It will be apparent to a person skilled in the art that number of carbon blocks in the vessels 102, 104 can be dependent on size of the system 100 and volume of water to be filtered by the system 100.

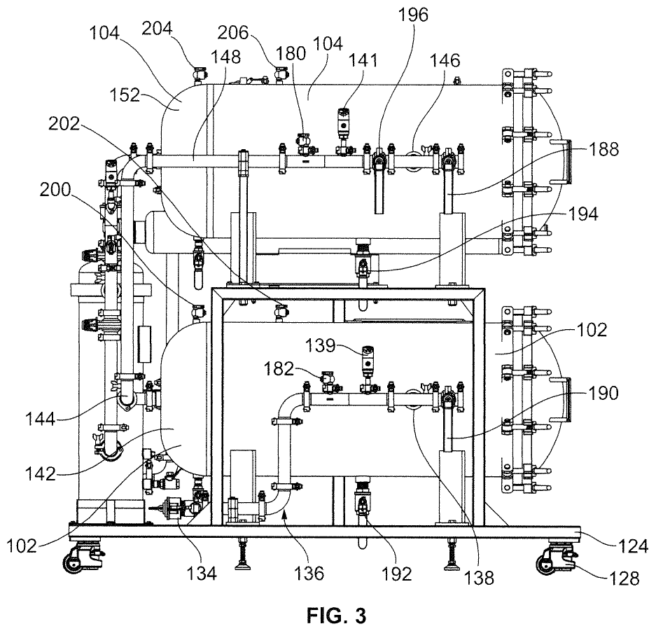

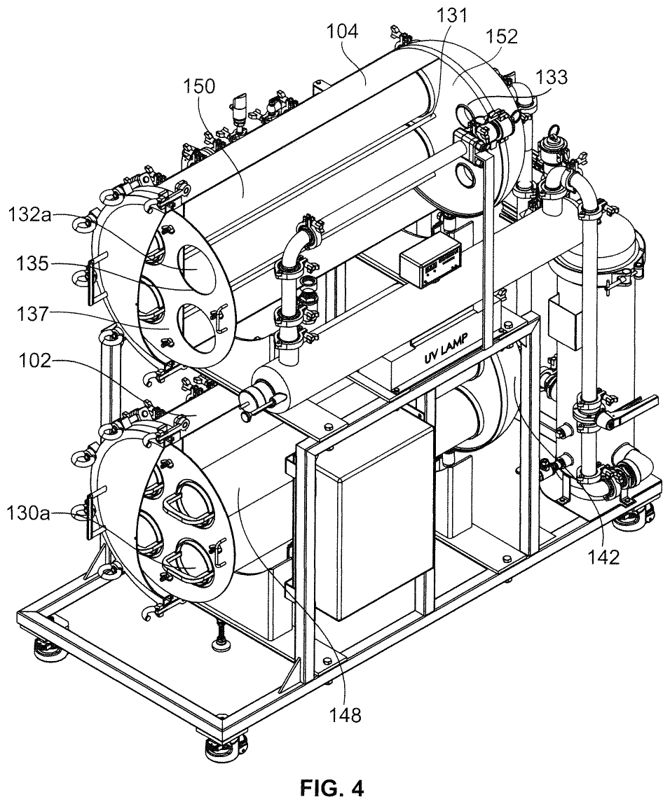

Referring to FIG. 3, for purification or filtration of water, the water is received from a water inlet connection 134. The water inlet connection 134 can be coupled to an external water source for receiving water supply. The water is supplied through a worker vessel inlet pipe 136 to the worker vessel inlet 138. A worker vessel inlet pressure sensor 139 is adapted to automatically monitor pressure of the inlet water in the worker vessel 102. Pressure is generally maintained within a range generally of 40 psi to 120 psi. Water is dechlorinated inside the worker vessel 102 using the carbon blocks 130a-d disposed therein. As illustrated in FIG. 4, inlet water pressurizes the worker vessel 102 and flows into the outer surface 148 of the carbon blocks 130a-d of the worker vessel 102, thereby filtering out chlorine and chloramines from the water. The dechlorinated water then flows through the center of the carbon blocks 130a-d into a back cannister 142 disposed at the rear end of the worker vessel 102.

The dechlorinated water from the worker vessel 102 flows out of the back cannister 142 of the worker vessel 102 into the polisher vessel 104. Specifically, the dechlorinated water is ejected from the worker vessel outlet 144 FIG. 3 and is transmitted to the polisher vessel inlet 146 via polisher vessel inlet pipe 148. Referring to FIG. 4, a cutaway view of the polishing vessel 104 shows a guide-rod 131 which guides the carbon blocks so that the distal end of the blocks will fit into openings 133 in in distal plate 152. The carbon blocks 132a-d are also supported by fitting into the openings 135 in the proximal faceplate 137. A similar structure for support of carbon blocks is also found in worker vessel 102. The dechlorinated water flows into the outer surface 150 of the carbon blocks 132a-d, filtering out any remaining chlorine and chloramines from the water, thereby also functioning as a backup safety feature for the worker vessel 102. The dechlorinated water then flows through the center of the carbon blocks 132a-d into the cannister 152 at the rear end of the polisher vessel 104 same as the worker vessel 102. A polisher vessel inlet pressure sensor 141 FIG. 3 is adapted to automatically monitor pressure of the water in the polisher vessel 104 and keep said pressure within the aforesaid acceptable range.

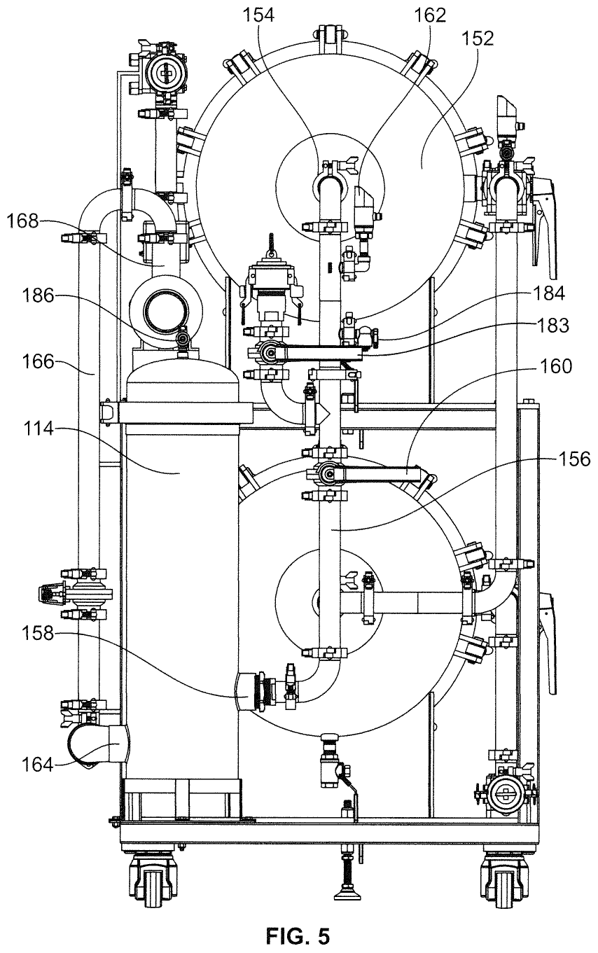

Referring now to FIG. 5, the dechlorinated water from the polisher vessel 104 flows via the cannister 152 into the multi-cartridge filter (MCF) 114. Specifically, the dechlorinated water is ejected through the polisher vessel outlet 154 and passes through the MCF inlet pipe 156 to the MCF inlet 158. MCF 114 UV sterilization unit 118 can be bypassed using the MCF shut off valve 160 and bypass valve 183 when is not required for filtration of water or maintenance is required. The dechlorinated water from the polisher vessel 104 flows into the outer surface of the MCF filter cartridges to filter out sediment and particles of a specific micron size. The pressure of water from the polisher vessel 104 to the MCF 114 can be monitored using polisher vessel outlet PSI sensor 162.

For UV processing of the water, the filtered water from the MCF 114 is transmitted to the UV-filtration unit 118 The water flows out of the MCF 114 via the MCF outlet 164 and is passed through the UV unit inlet pipe 166 to the UV inlet 168. The UV-filtration unit 118 performs UV disinfection of dechlorinated and MCF treated water sanitizing microbes, pathogens, and more.

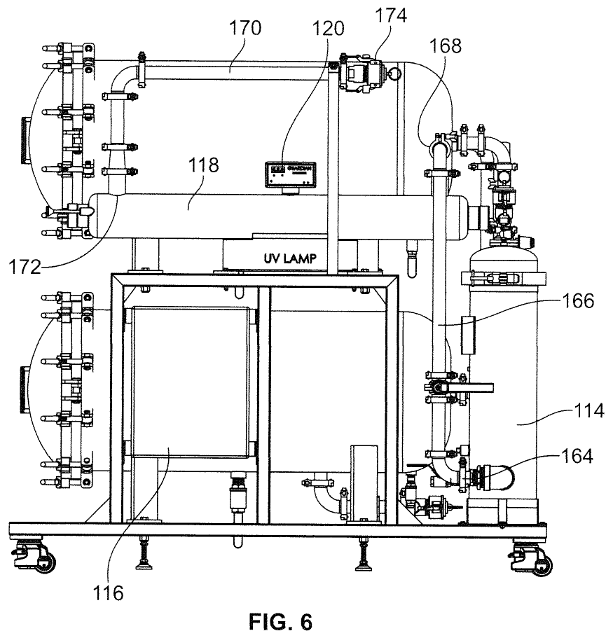

Referring to FIG. 6, the dechlorinated and MCF filtered water is received by the UV-filtration unit 118 and the unit 118 is monitored using UV light intensity monitor 120 The UV-disinfected water flows out of the UV-outlet 172 and is released to the skid outlet connection 174 via the UV-module pipe 170.

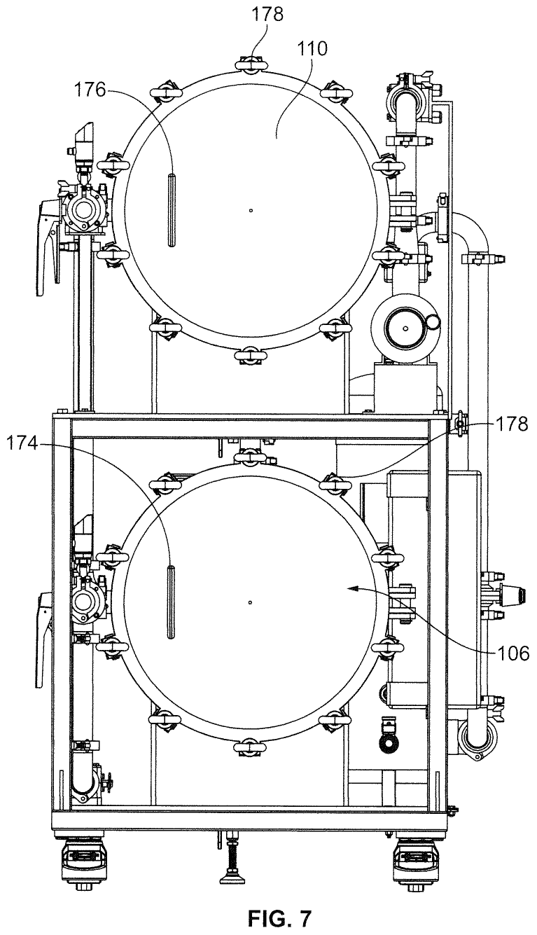

Referring to FIGS. 1 and 7, the lids 106, 110 include the corresponding handles 174, 176 for handling and operating the lids 106, 110 and for closing and opening the vessels 102, 104 respectively. The lids 106, 110 are bolted using a plurality of fasteners 178 for creating a sealed chamber inside the vessels 102, 104. Alternate forms of connection of the lids to the vessels could be used such as hinged doors with pressure latches and the like.

Referring again to FIG. 3, the system 100 contains individual sampling ports for manual or automatic sampling to test quality of water at different stages of the filtration process. The worker vessel sample port 180 is used for sampling the water received from the worker vessel 102 to the polisher vessel 104. The inlet sample port 182 is used for sampling the inlet water received by the worker vessel 102.

Referring again to FIG. 5, a polisher vessel outlet sample port 184 is used for sampling the water outputted from the polisher vessel 104. An MCF sample port 186 is used for purging air from the MCF module 114 when filters are replaced.

The system 100 preferably contains a plurality of two-way valves on the carbon block vessels inlet 138 to the worker carbon block vessel 102 and inlet 146 to the polisher carbon block vessel 104, that allow the worker carbon block vessel 102 to be bypassed. In the preferred embodiment, the worker carbon block vessel 102 is bypassed for performance testing on the polisher carbon block vessel 104, using a detachable connection piece to complete the bypass of the worker carbon block vessel 102.

Referring again to FIG. 3, a polisher vessel monitored bypass valves 188 & 196 is disposed for bypassing the polisher vessel 104 and a worker vessel monitored bypass valve 190 is disposed to bypass the worker vessel 102. A worker vessel drain port 192 is used for draining water from the worker vessel 102 and a polisher vessel drain port 194 is used for draining water from the polisher vessel 104. The drain ports facilitate easy maintenance and replacement of carbon blocks by allowing for efficient drainage of the vessels. A worker vessel air purge port 200 is used for purging air from the worker vessel product chamber and a worker vessel air purge port 202 is used for purging air from the worker vessel process chamber 102. A polisher vessel air purge port 204 is used for purging air from the polisher vessel product chamber and a polisher vessel air purge port 206 is used for purging air from the polisher vessel process chamber 104. The air purge ports facilitate easy maintenance and replacement of carbon blocks by allowing for efficient air purge from the upper portion of the vessels.

The system 100 of the present invention leverages the advantages of carbon block technology on a larger scale and offers a sustainable, cost-effective solution for water purification in large-scale dialysis settings, significantly reducing water usage and operational complexity compared to traditional GAC systems.

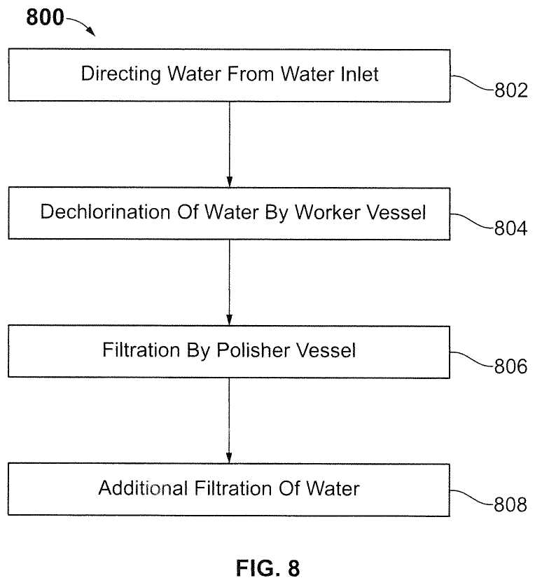

FIG. 8 illustrates a flow chart depicting a process of operation of the scalable carbon block water purification system for large-scale dialysis applications system of the present invention in accordance with the disclosed structure. Initially, water enters the system through the skid inlet 134 and is directed into the worker vessel 102 (Step 802). Then, the worker vessel 102 performs the bulk of contaminant removal using the carbon blocks disposed therein (Step 804). The partially purified water flows from the worker vessel 102 to the polisher vessel 104, where any remaining contaminants are removed (Step 806). This step ensures a high level of water purity and acts as a safeguard against worker vessel failure. Throughout the process, pressure sensors monitor the water pressure at key points to ensure optimal performance and sampling ports allow for manual or automatic water quality testing at different stages to verify the filtration effectiveness. After passing through the polisher vessel 104, water undergoes further treatment with optional equipment such as multi-cartridge filtration 114, UV filtration 118, or chlorine monitoring 115, depending on the specific end users' requirements (Step 808).

The system 100 consists of multiple large carbon block vessels designed to hold carbon blocks for water filtration and the vessels are mounted horizontally so that they can be opened from either end, facilitating easy replacement and maintenance of the carbon blocks. The pressure sensors monitor water pressure at various points such as incoming water pressure (inlet to skid, pre-worker vessel), pressure between the worker and polisher vessels (pre-polisher vessel), and outlet pressure (post-polisher vessel). A drop in pressure from intake to outlet of 15-30 psi or more is an indicator of the need to replace the carbon blocks.

A description of an embodiment with several components in communication with each other does not imply that all such components are required. On the contrary, a variety of optional components are described to illustrate the wide variety of possible embodiments of the disclosure. Further, there are other components also present in the substation communication network, however, these are not presented in the description to focus on the main features of the invention.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the present disclosure are intended to be illustrative, but not limiting, of the scope of the disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An apparatus, comprising:
a first carbon block vessel connected to a second carbon block vessel, wherein the first carbon block vessel and the second carbon block vessel are connected in series, the first carbon block vessel functions as a worker vessel, and the second carbon block vessel functions as a polisher vessel;
at lease one of said carbon block vessels includes multiple carbon blocks;
said apparatus including a support structure for holding said vessels;
said vessels being generally tubular in shape and mounted horizontally on said support structure;
one or more drain ports disposed on the first and second carbon block vessels;
one or more air purge ports disposed on the first and second carbon block vessels;
one or more pressure sensors connected to the first and second carbon block vessels;
one or more sampling ports connected to the first and second carbon block vessels; and
at least one bypass valve.

2. The apparatus of claim 1, wherein the first and second carbon block vessels each include a lid disposed at one end of the vessel to facilitate easy replacement and maintenance of carbon blocks.

3. The apparatus of claim 1, further comprising a multi-cartridge filtration unit connected in series with the second carbon block vessel for additional contaminant removal.

4. The apparatus of claim 1, further comprising a UV-filtration unit connected in series with the second carbon block vessel for limiting biological growth by exposing water to ultraviolet light.

5. The apparatus of claim 1, wherein the one or more pressure sensors are configured to measure the water pressure at the inlet to the first carbon block vessel, between the first and second carbon block vessels, and at the outlet of the second carbon block vessel.

6. The apparatus of claim 1, further comprising a chlorine monitor connected to the apparatus for measuring chlorine and chloramine levels in the water.

7. The apparatus of claim 1, further comprising levelling casters on said support structure.

8. A water purification system for large-scale dialysis applications, comprising:
at least two carbon block vessels connected in series, wherein the first carbon block vessel is configured as a worker vessel for primary removal of water contaminants and the second carbon block vessel is configured as a polisher vessel for removing any remaining contaminants;
at least one carbon block in each vessel;
a multi-cartridge filtration unit containing multiple filament filters;
a chlorine monitor configured to measure chlorine levels at various stages of water filtration;
a UV-filtration unit with a UV light intensity monitor; and
a metal frame supporting said vessels such that they are oriented horizontally.

9. The water purification system of claim 8, wherein the worker vessel and the polisher vessel each contain multiple carbon blocks for water filtration.

10. The water purification system of claim 8, wherein said vessels have a lid configured to enable the lid to be removed to provide access to the carbon blocks located inside said vessels.

11. The water purification system of claim 8, wherein the multi-cartridge filtration unit, chlorine monitor, and UV-filtration unit are optionally removable depending on user preference.

12. The water purification system of claim 8, wherein the system includes individual sampling ports for manual or automatic sampling to test the quality of water at different stages of the filtration process, including at least one sampling port associated with the worker vessel and one associated with the polisher vessel.

13. The water purification system of claim 8, further comprising two-way valves on the skid inlet water connection and the inlet to the polisher vessel, enabling the worker vessel to be bypassed for performance testing of the polisher vessel.

14. A method for purifying water in a large-scale dialysis application, comprising:
directing incoming water into a first carbon block vessel configured as a worker vessel, wherein the worker vessel performs primary removal of contaminants from the water;
channeling the partially purified water from the worker vessel to a second carbon block vessel configured as a polisher vessel, wherein the polisher vessel removes any remaining contaminants from the water;
monitoring water pressure at multiple points in the system using one or more pressure sensors connected to the worker vessel and the polisher vessel;
sampling water at various stages of the filtration process using one or more sampling ports connected to the worker vessel and the polisher vessel; and
enabling bypass of the worker vessel using at least one bypass valve for performance testing of the polisher vessel.
